(19) United States
(12) Patent Application Publication
(10) Pub. No.: US 2024/0107995 A1
(43) Pub. Date: Apr. 4, 2024

(54) MOTORIZED ANIMAL DECOY

(71) Applicant: Tyler J. Baskfield, Denver, CO (US)

(72) Inventor: Tyler J. Baskfield, Denver, CO (US)

(21) Appl. No.: 18/374,394

(22) Filed: Sep. 28, 2023

Related U.S. Application Data
(60) Provisional application No. 63/411,373, filed on Sep. 29, 2022.

(51) Int. Cl. A01M 31/06

(52) U.S. Cl. CPC A01M 31/06

(57) ABSTRACT

A motorized waterfowl decoy can include a motor and power source (e.g., a battery). The shaft of the motor turns a flexible shaft, leg, cord or dowel that pushes against the ground, stand/stake of the decoy to impart movement to the decoy so that it moves in a realistic and random way. The weight location can be adjusted to change the balance of the decoy on its stand or stake to provide additional movement or wobbling. The flex of the shaft that imparts the movement can be selected such that it can push against the ground or other object to move the decoy, yet deflect enough to pass by the ground or stand for a next cycle of movement as it is turned by the motor. Shafts with different types and levels of flexibility can be used to create different types of movement for the decoy.

### PRIORITY

This application claims the priority benefit of U.S. Provisional Application No. 63/411,373, filed on Sep. 29, 2022, which is hereby incorporated herein by reference in its entirety.

### FIELD

The present invention relates generally to animal decoys such as waterfowl decoys used for hunting and, more particularly, to waterfowl decoys that are motorized to mimic lifelike movement of waterfowl.

### BACKGROUND

Waterfowl hunting is a popular sport enjoyed by hundreds of thousands of individuals in the United States of America and elsewhere in the world. Decoys are often used to attract the target species of waterfowl and often made to look like a particular species of waterfowl. The hunter sets up one or more decoys in an area thought to be used by the target waterfowl. Decoys featuring realistic movement are often used because the realistic movement aids in attracting the desired waterfowl and brings them into a range where they can be harvested effectively and humanely.

Popular types of decoys include “full body” and “silhouette” decoys. Full body decoys are essentially statues that look like the actual species in its normal habitat. Silhouette decoys are essentially a 2-dimension photograph of a waterfowl species staked into the ground in order to look like real species in their normal habitat. Most decoy types are designed to move in the wind and look more realistic due to the movement. Unfortunately, wind is an unreliable source of movement because of its unpredictability.

It is common knowledge among waterfowl hunters that motion decoys, those exhibiting some form of animation that adds motion similar to waterfowl behaving naturally in their normal habitat, are more likely to attract waterfowl than are traditional static decoys. For example, U.S. Pat. Nos. 6,553,709, 8,997,394 and 11,083,189 each disclose a duck decoy that includes motorized features. U.S. Pat. Nos. 8,997,394 and 11,083,189 are both incorporated by reference herein in their entirety as part of this application. However, each of the foregoing motorized decoys is adapted to movement on a body of water. There is a continuing need to provide motorized decoys with lifelike movement that can be deployed on land.

### SUMMARY

The present invention addresses the problems discussed above by providing motorized waterfowl decoys that provide realistic, consistent and random movement when deployed on land or in shallow water in order to more effectively attract waterfowl.

The invention makes waterfowl decoys more effective by providing a reliable source of random movement. The invention, according to certain embodiments, can be adapted or retrofitted to a wide variety of existing decoy styles and species.

In one example, a motor and power source (e.g., a battery) are attached to the decoy. The shaft of the motor turns a flexible shaft, leg, cord or dowel that pushes against the ground or stand/stake of the decoy to impart movement to the decoy so that it moves in a realistic and random way. The weight and/or location of components can be adjusted to change the balance of the decoy on its stand or stake to provide additional movement such as wobbling.

The flex of the shaft or leg that imparts the movement can be selected such that it can push against the ground or other object to move the decoy, yet deflect enough to pass by the ground or stand for a next cycle of movement as it is turned by the motor. Shafts with different types and levels of flexibility and length can be used to create different types of movement for the decoy.

The invention in certain embodiments can be attached anywhere on any type of decoy. A cord or strap can be secured to the decoy body in order to create a strong and effective means to attach the motor and or battery (power source) to drive the motion system that moves the decoy.

In an example, a motion assembly for a wildlife decoy can include a motor, a leg coupled to an output shaft of the motor such that the leg rotates as the output shaft rotates and a power source electrically coupled to the motor. The leg comprises an elongated shaft. The leg is coupled to the output shaft such that a distal end of the leg can contact ground or a base of the wildlife decoy as the leg is rotated by the motor.

In an example of a waterfowl decoy system, the system includes a decoy body and a motion assembly configured to be secured to the decoy body. The motion assembly can include a motor, a leg coupled to an output shaft of the motor such that the leg rotates as the output shaft rotates and a power source electrically coupled to the motor. The leg comprises an elongated shaft. The leg is coupled to the output shaft such that a distal end of the leg can contact ground or a base of the wildlife decoy as the leg is rotated by the motor. The decoy body can be a full body decoy or a silhouette decoy.

A flag, a tag or a strobe can be disposed on the leg such that the flag, tag or strobe rotates along with the leg. The elongated leg can be coupled to the output shaft of the motor via an S-shaped clip. The power source can be electrically coupled to the motor via a power conduit. An on/off switch can be electrically coupled to the motor.

A microprocessor can be electrically coupled to the motor. The microprocessor can be programmed to periodically operate the motor according to a programmed movement routine. The microprocessor can also be programmed to cycle through a series of different movement routines, and an on/off state, in response to an input supplied by a user.

A wireless interface can be electrically coupled to the microprocessor, and the microprocessor can be programmed to respond to inputs wirelessly provided by a user. The wireless inputs can be provided via the user's smartphone or via a handheld remote control.

An attachment clip can be coupled to the motor and/or the power source so that the motion assembly can be secured to the decoy body. The attachment clip can be configured to grasp a portion of the wildlife decoy or an attachment harness disposed on the wildlife decoy. In one example, the attachment clip comprises a spring-actuated grasping clip.

The power source can be a battery. The battery can include a battery monitor circuit and a charging circuit. A battery status light can be provided so that the user can readily determine via observation a charge state of the battery.

The decoy body in certain examples is configured to rotate about a vertical axis. The motion assembly is secured to the decoy body such that the leg rotates about a horizontal axis or an axis at an oblique angle to the vertical axis such that the distal end of the leg contacts the ground or a base of the waterfowl decoy as the leg rotates.

A harness configured to fit over the decoy body can be provided. The motion assembly can be attached to the harness.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings.

FIG. 1 is a perspective view of a motion assembly coupled to a decoy body in accordance with embodiments of the present invention.

FIG. 2 is a bottom view of a decoy body in accordance with embodiments of the present invention.

FIG. 3 is a perspective view of a decoy body coupled with a harness in accordance with embodiments of the present invention.

FIG. 4 is a perspective view of a harness for a decoy body in accordance with embodiments of the present invention.

FIG. 5 is a perspective view of a decoy body in accordance with embodiments of the present invention.

FIG. 6 is a perspective view of a motion assembly coupled to a decoy body in accordance with embodiments of the present invention.

FIG. 7 is a side view of a motion assembly in accordance with embodiments of the present invention.

FIG. 8 is an exploded diagram view of components of a motion assembly in accordance with embodiments of the present invention.

FIG. 9 is a further diagram view of components of a motion assembly in accordance with embodiments of the present invention.

FIG. 10 is a side view of a leg assembly for a motion assembly in accordance with embodiments of the present invention.

FIG. 11 is a perspective view of a motion assembly to be coupled to a decoy body in accordance with embodiments of the present invention.

FIG. 12 is a perspective view of a silhouette decoy body in accordance with embodiments of the present invention.

FIG. 13 is a side view of a motion assembly coupled to a silhouette decoy body in accordance with embodiments of the present invention.

FIG. 14 is an end view of a motion assembly coupled to a silhouette decoy body in accordance with embodiments of the present invention.

FIG. 15 is a diagram of part of a motion assembly in accordance with embodiments of the present invention.

FIG. 16 is a diagram of part of a motion assembly in accordance with embodiments of the present invention.

FIG. 17 is a diagram of part of a motion assembly in accordance with embodiments of the present invention.

FIG. 18 is a diagram of part of a motion assembly in accordance with embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives falling within the spirit and scope of the invention as defined by the appended claims. For illustrative purposes, hatching or shading in the figures is provided to demonstrate sealed portions and/or integrated devices for the package.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. It is understood that the features mentioned hereinbefore and those to be commented on hereinafter may be used not only in the specified combinations, but also in other combinations or in isolation, without departing from the scope of the present invention.

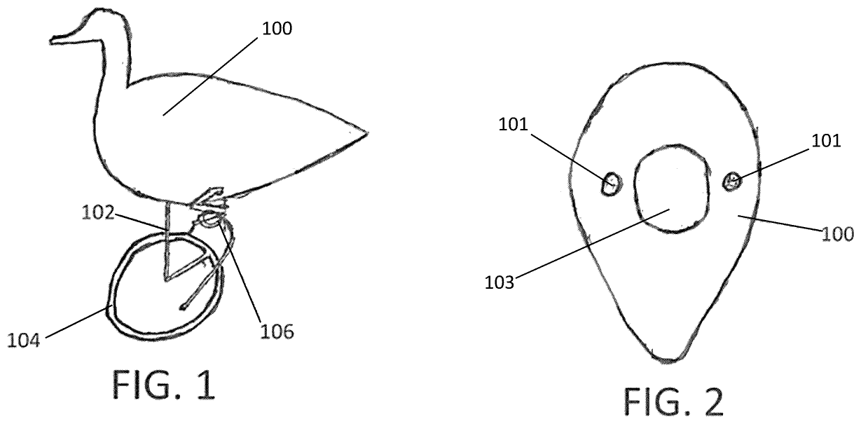

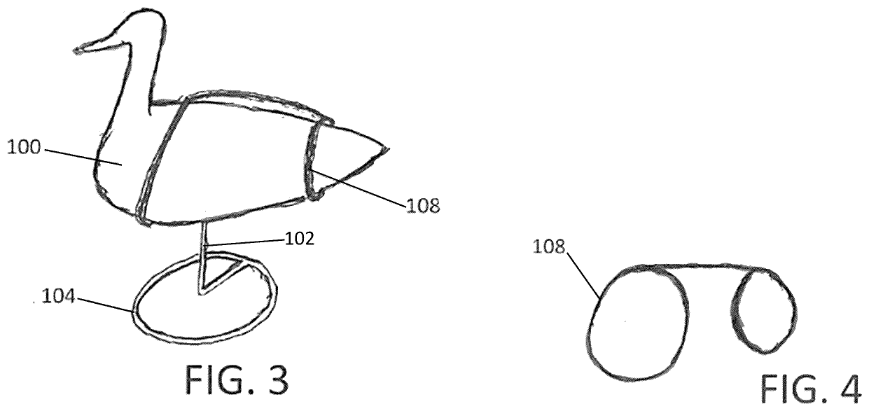

Referring to FIGS. 1-4, a waterfowl decoy body 100 is rotationally mounted atop a stand, stake or shaft 102. The decoy can rotate about the vertical axis defined by the longitudinal extension of the shaft 102. The shaft 102 can also be attached to a stationary base 104 that sits upon the ground, or the shaft 102 can be directly secured to the ground. A motion assembly 106 is secured to the decoy body to cause the decoy body 100 to rotate about the rotation axis of the shaft 102. The decoy body 100 defines leg attachment holes 101, and a hole or receiving aperture 103 for receiving the stand, stake or shaft 102.

The motion assembly 106 can be secured to the decoy body 100 in a variety of ways, including one or more elastic straps (e.g. bungee straps) that can be formed into a harness 108 that the user can secure over the decoy body 100. The elastic straps of the harness 108 hold the motion assembly 106 against a bottom or other portion of the decoy body 100 so that the operation of the motion assembly 106 causes the decoy body 100 to rotate about the stand, stake or shaft 102. The harness allows the motion assembly 106 to be retrofit to a wide variety of full body waterfowl decoy shapes, sizes and types.

The motion assembly 106 can also be secured to the body 100 with mechanical fasteners (e.g. bolts, clips) or the motion assembly 106 can be built into the body 100. Other fastening means can be employed without departing from the scope of the invention.

The invention can be embodied, for example, as a motion imparting system, kit, device or method that can be applied to or retrofitted to existing animal decoys. The invention can also be embodied in a further example as a decoy with motion capabilities.

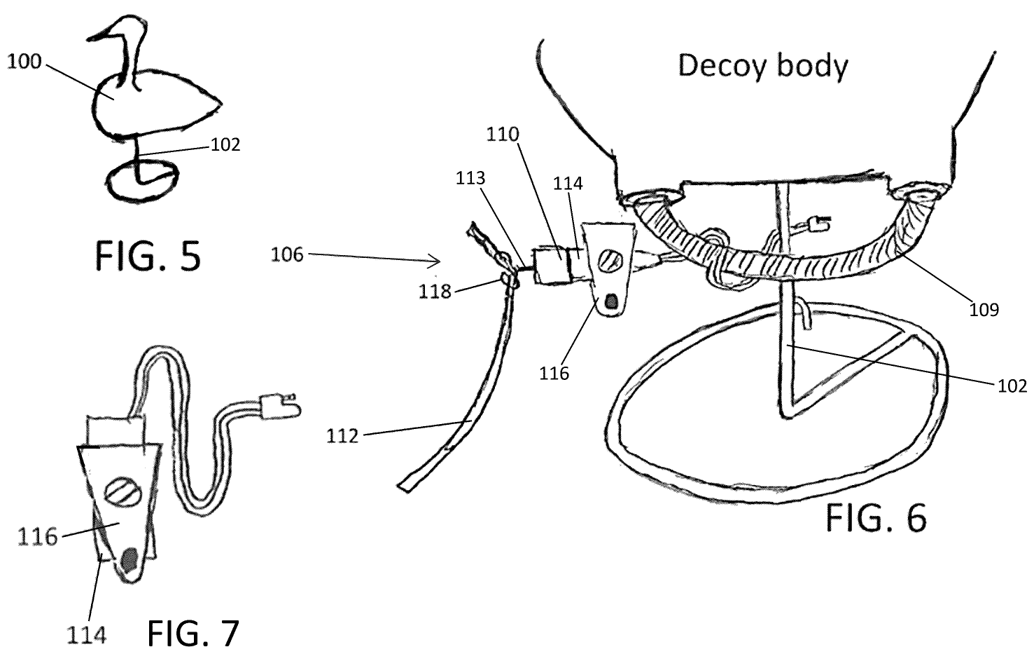

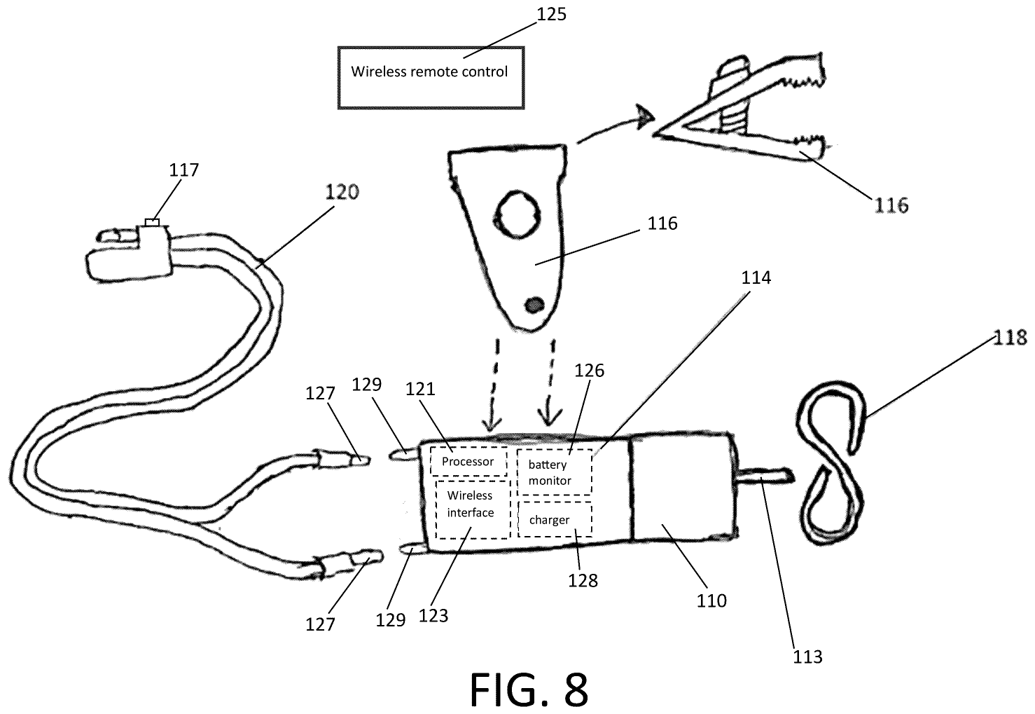

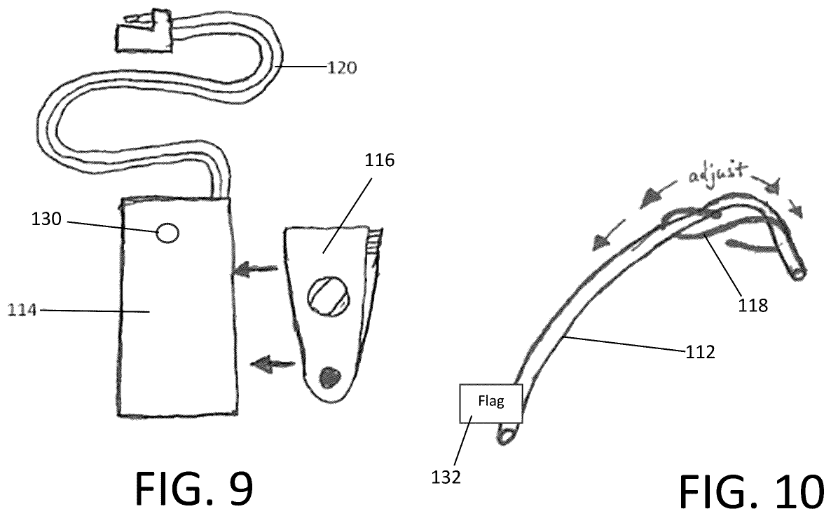

Referring additionally to FIGS. 5-10, the decoy body 100, such as shown in FIGS. 5-6, is provided with a motion assembly 106. The motion assembly 106 comprises a motor 110, a leg 112 coupled to the output shaft 113 of the motor 110, and a power source 114 coupled to the motor 110. An attachment clip 116 fastened to the motor 110 is provided to secure the motion assembly 106 to the decoy body 100. For example, an elastic strap or section of flexible cord 109 (e.g. bungee cord) is secured to the decoy body, such as via insertion into the leg attachment holes 101.

A leg fixture 118 is rotationally secured to the distal end of the motor's output shaft 113 to facilitate rotationally coupling the leg 112 to the motor 110. The fixture 118 can be a S-shaped clip so that the leg 112 passes through each end of the S-shape. The relative placement of the S-shaped clip relative to the distal end that contacts the ground can be adjusted as indicated in FIG. 10 to adjust the flex of the leg 118, and thereby adjust the motion imparted on the decoy body 100.

A power conduit 120 can be provided between the power source 114 (hereinafter the “battery”) and the motor 110. The conduit 120 can be coupled to the battery 114 via respective terminals 127, 129 or can be hard wired to the battery 114.

An on/off switch 117 can be provided to the battery 114, power conduit 120 or the motor 110 such that the motor 110 can be selectively powered on and off. In one example, a microprocessor or microcontroller (hereinafter, processor 121) is provided in the motion assembly 106 (or in the battery 114 or integrated into the motor 110 housing) and coupled to the motor 110 to drive the motor 110 according to a pre-programmed routine selected by the user. For example, the rotation of the decoy body 100 can be periodic with pauses of variable length between periods of movement (e.g. frequency), the speed of movement can be varied, the direction of movement can be changed, and the degrees of movement in a given direction can be preset and varied. The user can press a button (e.g., the on/off button 117) provided to the motion assembly 106 or the battery 114 to cycle the controller through a series of different movement routines and an on/off setting.

In a further embodiment, a wireless interface 123, such as BLUETOOTH, can be provided to the motion assembly 106 to allow the user to remotely control operation of the motion assembly 106, and thus, the decoy's movement. A handheld remote control 125 can be provided for the user. The handheld remote control 125 can be the user's smartphone that has an app loaded into its memory to operate the motion assembly 106 for the decoy remotely.

The battery 114 can be a lithium-based chemistry battery or other battery type. The battery 114 can comprise one or more cells to achieve any desired voltage and capacity. The battery 114 also may comprise a battery monitor circuit 126 and a charging circuit 128. A charge status indicator 130, such as a red/green LED can be provided so that the user can readily determine via observation a charge state of the battery 114.

In certain embodiments, the battery 114 can be disposed inside of a sealed enclosure that is formed of a plastic material and/or rubber material. In one example, the enclosure comprises a two-piece plastic clamshell. A rubber gasket is provided along the mating edges of the clamshell portions to form the watertight seal. Silicone or other sealant types can be applied to ensure that the enclosure is sufficiently secured together and is watertight to the desired depth.

In an alternative embodiment, the battery 114 is encapsulated by a protective outer material (versus contained within an enclosure) to form an encapsulated power system. The outer protective material can be a plastic or rubber material that is molded around the battery and at least a portion of the power conduit 120.

Alternatively, the outer protective material can be an environmentally friendly material which is molded at a sufficiently low temperature to allow for the battery 114 and its controlling circuit board to be molded around completely with the protective material without overheating, burning or melting the battery or its controlling circuit board.

A suitable material for encapsulating the battery 114 and its circuit components via a molding operation is made from the fatty acids of plants, rather than being plastic. Such material and the corresponding manufacturing process are more environmentally friendly than conventional plastic molding materials and processes. The outer protective material can be poured over the battery in a mold and allowed to harden.

In a further alternative, the battery 114 and its electronics are potted. For example, an epoxy or urethane material is used to completely cover the battery assembly to exclude moisture from reaching the battery or its electronic components.

The clip 116 in one embodiment is a spring-actuated grasping clip that allows the motion assembly 106 to be attached anywhere on the decoy, with the most universal spot being the legs or area designed to accept the shaft 102 of the decoy, or the shaft 102 itself. An attachment harness 108 can also be provided as described above.

The weight of the motor 110, and the ability to attach it to the elastic cords 109 or feet that are on most full body decoys or other locations on the decoy, allows the weight of the motor 110 to add movement to the decoy as the motor's weight shifts locations while the decoy rotates, thereby imparting a seemingly random movement.

The leg 112 of the motion assembly 106 can be configured as an elongated flexible shaft. For example, the leg 112 can be formed of a plastic, metal wire or fiber glass material, or can be another material with the desired flex properties. The leg 112 is secured to the motor shaft 113 and rotates via the motor 110. As the leg 112 rotates about the motor shaft 113, a distal longitudinal end thereof 115 contacts the ground (or a part of the base 104) to propel the decoy body 100 about the decoy body's rotational axis. The rotational speed and frequency of the decoy body can be adjusted by changing the speed of the motor 110 and the flex of the leg 112.

In certain embodiments the leg 112 can engage the ground with sufficient force to impart a translational movement and/or a wobbling movement to the decoy in addition to rotating the decoy body 100 about its vertical rotational axis.

The flex characteristic of the leg 112 can be selected such that the leg 112 can engage the ground or other object to rotate the decoy, yet deflect enough to pass by the ground or base 104 for a next cycle of movement as it is turned by the motor 110. Shafts with different flex characteristics can be used to create different types of movement for the decoy. Moreover, the height of the shaft from the ground or the overall length of the shaft between the motor shaft 113 and the ground can be adjusted to allow for more effective movement for more styles or types of waterfowl decoys deployed on different types of ground cover.

As shown in FIG. 10, a flag 132 or tag can be secured to the leg 112. The flag 132 or tag can be colored or reflective to catch the attention of waterfowl as the leg is rotated. The flag can also comprise a light, and particularly a flashing or strobing light, to attract attention of the target waterfowl.

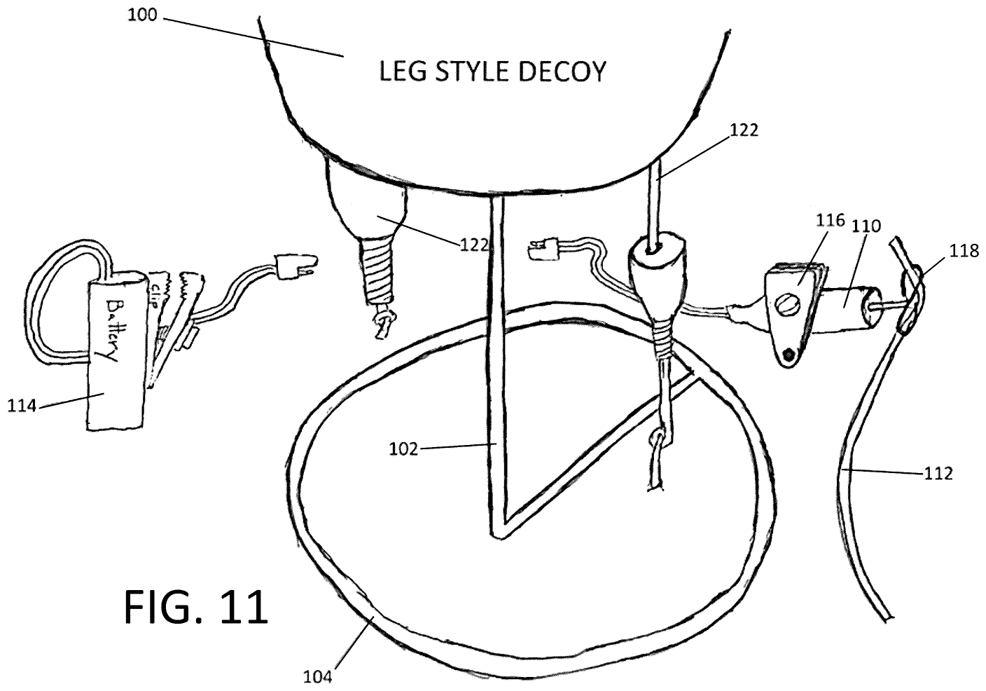

Referring now to FIG. 11, an example arrangement of components is shown for a leg-style decoy 100. This decoy style includes legs 122 that are attached to the body 100 via flexible cords. Both the battery 114 and the motor 110 have clips 116 to facilitate attachment to a respective one of the legs 122 of the decoy body 100 or to the cords that are used to attach the legs 122

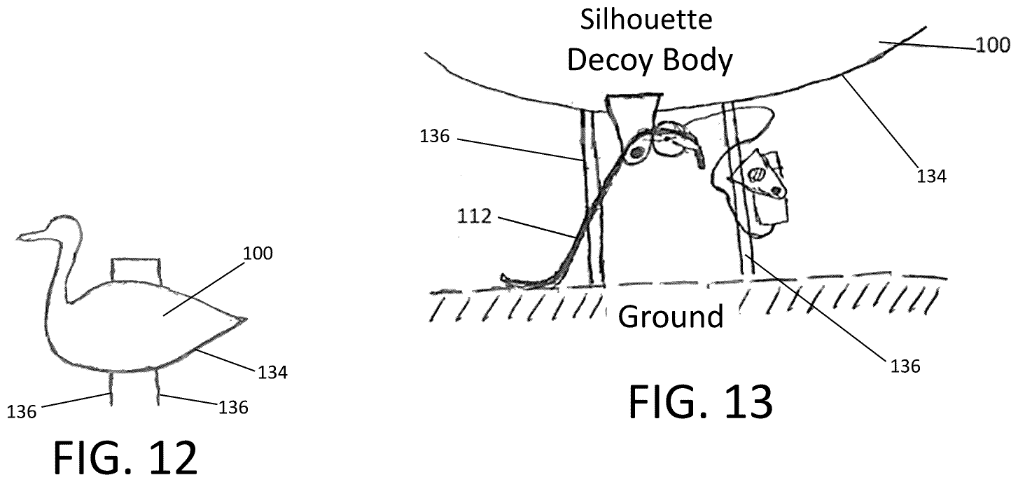

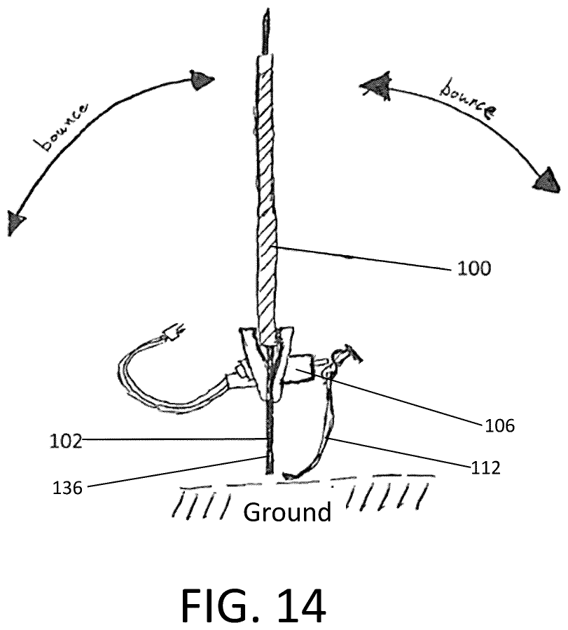

Referring now to FIGS. 12-14, an arrangement of components for a silhouette-type decoy 100 are shown. The silhouette-type decoy 100 comprises a metal wire or plastic member forming a perimeter frame 134. The two-dimensional picture 136 of the waterfowl is attached to this framework 134. A pair of legs 136 protrude downwards and can be staked into the ground. The motion assembly 106 can be attached via the clip 116 to a portion of the frame 134 or one of the legs 136. As the leg 112 of the motion assembly 106 rotates, the decoy body 100 will bounce from side to side as viewed from the front or rear edges. This will resemble a wobbling motion of a waterfowl. The degree of side-to-side deflection and the frequency can be adjusted as explained above.

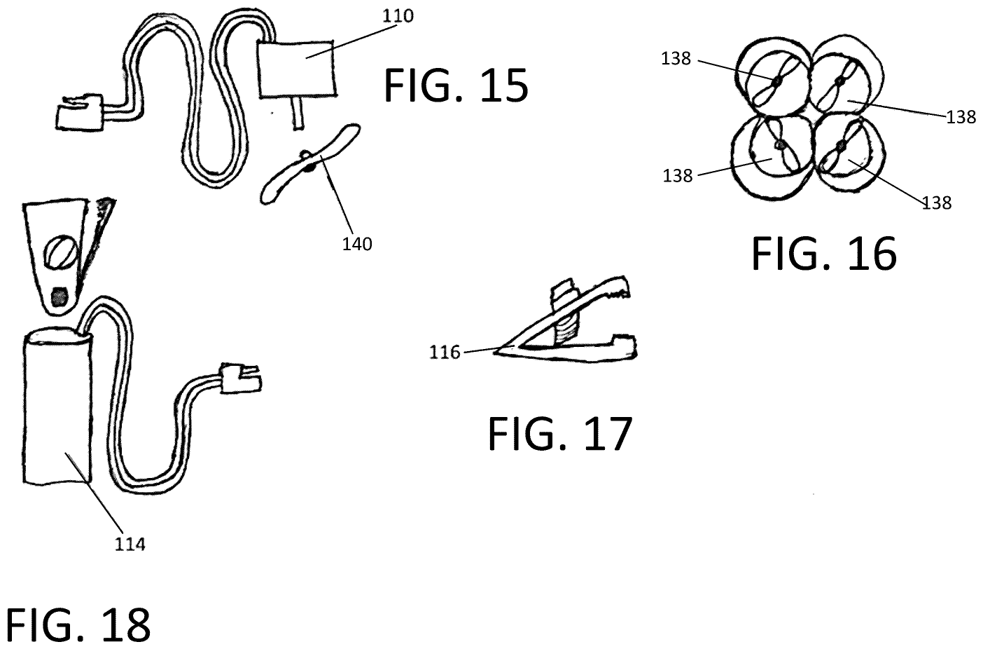

Referring to FIGS. 15-18, an alternative configuration of components for the motion assembly 106 is shown. In this example, the rotating leg 112 is replaced with one or more fans 138. The fans 138 can be, for example, the same type of fans used in drone aircraft. The fans 138 can also be a simple fan blade or propeller 140 attached to the end of a motor shaft.

The fan 138 or fan blade 140 creates a motion imparting force by moving air to impart rotational movement (or wobble) to the decoy body 100. The motor 110 and fan(s) 138 can be secured to the decoy body 100 with clips 116 or other means such as those discussed herein. The battery 114 can be provided as discussed herein. The fan's speed can be adjusted to change the rotational speed, and the fan 138 can be pulsed or paused to impart a frequency of rotation that the user desires. Pulsing the fan 138 can also cause the decoy to wobble about its base which adds to the realistic movement.

In a further embodiment, both of the fan-based motion assembly 106 and the leg-based motion assembly 106 can be attached to the same decoy body 100 to impart even more complex and varied movement of the decoy body.

In use, the decoy body 100 is disposed on a rotating base. The motion assembly 106 is secured to the decoy body 100 before or after the mounting. The power source 114 is connected and the motion assembly 106 is turned on. The rotating leg 112 and/or fans 138 then impart a rotational movement (and other movement such as translating and/or wobbling) to the decoy body 100. Speed and frequency of the decoy body's movement can be adjusted by the user or controlled via a pre-set program executed by a microprocessor or microcontroller (processor).

In an example embodiment, a motorized waterfowl decoy is provided as a kit that further includes the motion assembly 106 and a battery 114. A charger, plug adaptor and/or other accessories can also be included in the kit. A remote control can also be provided in the kit.

The present invention may be embodied in other specific forms without departing from the spirit or essential attributes thereof, and it is, therefore, desired that the present embodiment be considered in all respects as illustrative and not restrictive. Those skilled in the art may recognize other equivalents to the specific embodiment described herein which equivalents are intended to be encompassed by the claims attached hereto.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A motion assembly for a wildlife decoy, the motion assembly comprising:
a motor, including an output shaft;
a leg coupled to the output shaft of the motor such that the leg rotates as the output shaft rotates, wherein the leg comprises an elongated shaft;
a power source electrically coupled to the motor,
wherein the leg is coupled to the output shaft such that a distal end of the leg can contact ground or contact a base of the wildlife decoy as the leg is rotated by the motor.

2. The motion assembly of claim 1, wherein a flag, a tag or a strobe are disposed on the leg such that the flag, tag or strobe rotates along with the leg.

3. The motion assembly of claim 1, wherein the elongated leg is coupled to the output shaft of the motor via an S-shaped clip.

4. The motion assembly of claim 1, further comprising a power conduit, wherein the power source is electrically coupled to the motor via the power conduit.

5. The motion assembly of claim 1, wherein the power source is a battery.

6. The motion assembly of claim 1, further comprising an on/off switch electrically coupled to the motor.

7. The motion assembly of claim 1, further comprising a microprocessor electrically coupled to the motor, the microprocessor programmed to periodically operate the motor according to a programmed movement routine.

8. The motion assembly of claim 7, wherein the microprocessor is programmed to cycle through a series of different movement routines and an on/off setting in response to an input supplied by a user.

9. The motion assembly of claim 7, wherein the motion assembly further includes a wireless interface electrically coupled to the microprocessor, and wherein the microprocessor is programmed to respond to inputs wirelessly provided by a user.

10. The motion assembly of claim 9, wherein the inputs are provided via the user's smartphone.

11. The motion assembly of claim 9, wherein the inputs are provided via a handheld remote control.

12. The motion assembly of claim 1, further comprising an attachment clip coupled to the motor and/or the power source, the attachment clip configured to grasp a portion of the wildlife decoy or an attachment harness disposed on the wildlife decoy.

13. The motion assembly of claim 12, wherein the attachment clip comprises a spring-actuated grasping clip.

14. The motion assembly of claim 1, wherein the power source is a battery, and the battery includes a battery monitor circuit and a charging circuit.

15. The motion assembly of claim 1, wherein the power source is a battery, and wherein the motion assembly further comprises a battery status light so that the user can readily determine via observation a charge state of the battery.

16. A waterfowl decoy system, comprising:
a decoy body; and
a motion assembly configured to be secured to the decoy body, the motion assembly comprising:
a motor, including an output shaft;
a leg coupled to the output shaft of the motor such that the leg rotates as the output shaft rotates, wherein the leg comprises an elongated shaft;
a power source electrically coupled to the motor,
wherein the leg is coupled to the output shaft such that a distal end of the leg can contact ground or a base of the decoy body as the leg is rotated by the motor.

17. The waterfowl decoy system of claim 16, wherein the decoy body is a silhouette decoy.

18. The waterfowl decoy system of claim 16, wherein the decoy body is configured to rotate about a vertical axis, and wherein the motion assembly is secured to the decoy body such that the leg rotates about a horizontal axis or an axis at an oblique angle to the vertical axis such that the distal end of the leg contacts the ground or a base of the waterfowl decoy as the leg rotates.

19. The waterfowl decoy system of claim 16, further comprising a harness configured to fit over the decoy body and to which the motion assembly can be attached.

20. The waterfowl decoy system of claim 16, wherein the motion assembly further comprises an attachment clip coupled to the motor and/or the power source, the attachment clip configured to grasp a portion of the decoy body or an attachment harness disposed on the decoy body.
